(19) United States
(12) Patent Application Publication
(10) Pub. No.: US 2002/0132524 A1
(43) Pub. Date: Sep. 19, 2002

(54) Low-emission electrical module

(76) Inventors: Mario Festag, Berlin (DE); Uwe Fischer, Berlin (DE); Andreas Stockhaus, Berlin (DE)

Correspondence Address: LERNER AND GREENBERG, P.A., Post Office Box 2480, Hollywood, FL, 33022-2480, US

(21) Appl. No.: 10/101,717

(22) Filed: Mar. 18, 2002

(30) Foreign Application Priority Data
Mar. 16, 2001 (DE) 101 14 143.2

(51) Int. Cl. H01R 13/648

(52) U.S. Cl. 439/607

(57) ABSTRACT

The electrical module, in particular an optoelectronic transceiver, has a coupling region for connection of a plug connector. The coupling region projects out of a metallic structure, which surrounds a shielding housing, when the module is arranged on a printed circuit board in the shielding housing. The coupling region is composed of plastic. This prevents the coupling region from acting as an antenna and interference emissions, which are produced by radio-frequency signals in the module, from being emitted in an amplified manner.

### BACKGROUND OF THE INVENTION

Field of the Invention

The invention relates to an electrical module, in particular an optoelectronic transceiver and to an assembly having such a module. More specifically, the electrical module is, in particular an optoelectronic transceiver having a coupling region for connection of a plug connector, with the coupling region projecting out of a metallic structure, which surrounds a shielding housing, when the module is arranged on a printed circuit board in the shielding housing.

It is known for optoelectronic transceivers to be connected to an optical network via optical plug connectors. In particular, so-called small form factor (SFF) transceivers and small form factor pluggable (SFP) transceivers of a small type are known, which are arranged on a printed circuit board in a shielding housing. The transceivers can thereby be designed such that they can be plugged in (SFP transceivers) or such that they can be permanently connected to the shielding housing (SFF transceivers).

The shielding housing is normally arranged inside a metallic structure, in particular the rear wall (backplane) of a metallic housing. In order to input or output infrared light into or out of the transceiver, a coupling region of the transceiver projects out of an opening in the metallic structure. One or more optical plug connectors can be connected to the coupling region. The optical coupling region is thus located outside the metallic structure.

Undesirable radiated interference emissions now occur at data transmission rates in the Gbit/s range, and are emitted to the outside world, especially in the coupling region of the optoelectronic transceiver, since there is a discontinuity in the shielding housing in the coupling region.

In order to reduce the electromagnetic radiated interference emissions that occur, it has been known for the shielding housing to be formed metallically, or to be metallized, as completely as possible. However, the radiated interference emissions can be reduced only to a limited extent in this way owing to the unavoidable discontinuity in the shielding plate in the coupling region of the transceiver.

### SUMMARY OF THE INVENTION

It is accordingly an object of the invention to provide an electrical module and an assembly having an electrical module, which overcomes the above-mentioned disadvantages of the heretofore-known devices and methods of this general type and which reduce the interference emissions in the coupling region of the module.

With the foregoing and other objects in view there is provided, in accordance with the invention, an electrical module, in particular an optoelectronic component, comprising:

a module body formed with a coupling region;

the module body being configured for insertion into a metallic structure-encased shielding housing on a printed circuit board;

the coupling region projecting out of the metallic structure encasing the shielding housing when the module is disposed in the shielding housing and the coupling region being composed of plastic.

With the above and other objects in view there is also provided, in accordance with the invention, an assembly, comprising:

a shielding housing disposed on a printed circuit board in a metallic structure, the metallic structure having a cutout formed therein;

an electrical module disposed in the shielding housing and having a coupling region for connection of a plug connector projecting out of the cut-out in the metallic structure, the electrical module being composed of plastic material.

In other words, the invention provides for the coupling region, which projects out of a metallic structure, of the electrical module to be formed from plastic. This reduces the emission of electromagnetic radiation, since the region which projects out of the metallic structure can now no longer act as a source of radiation, in the sense of an antenna. Interference emissions which are produced in the module cannot be transported to the coupling region, since the coupling region is formed from plastic, and thus cannot be radiated out of the metallic structure from there. This therefore prevents interference potentials from being passed at all to the coupling region, which is located outside the shielding metallic structure.

In one preferred refinement of the invention, not only is the coupling region of the electrical module formed from plastic, but also the housing of the electrical module. In this case, the housing is preferably formed from two housing shells , which are composed of plastic and surround a printed circuit board with electrical and/or optoelectronic components. Producing both the coupling region and the housing of the electrical module from plastic further reduces the emission of electromagnetic waves. It is thus impossible for any interference emissions to be passed via the housing, which is composed of plastic, in the direction of the discontinuity in the shielding housing.

In accordance with a preferred refinement of the invention, an inner shielding plate, which has contacts for making contact with the shielding housing in its edge region, is provided as the only metallic element of the module (apart from metallic parts of the electrical and/or optoelectronic components). The inner shielding plate is in this case preferably arranged adjacent to the coupling region and parallel to the metallic structure, in order to shield the discontinuity in the shielding housing as well as possible. However, there is an essential requirement for openings in the inner shielding plate for structures to pass through, via which the electrical module is coupled to a plug connector.

An electromagnetically absorbent plastic is preferably, but not necessarily, used as the plastic for the coupling region and/or for the housing of the electrical module, which absorbs as well as possible the electromagnetic radiation which passes through the plastic in the frequency band above 16 GHz that is preferably considered. Suitable electromagnetically attenuating fillers may be added to the plastic if required, for this purpose.

Other features which are considered as characteristic for the invention are set forth in the appended claims.

Although the invention is illustrated and described herein as embodied in a low-emission electrical module, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective schematic view of the assembly of an optoelectronic transceiver in a shielding housing on a printed circuit board;

FIG. 2 is a perspective view of an optoelectronic transceiver according to the invention and a shielding housing which is arranged on a printed circuit board, in the unassembled state;

FIG. 3 is a perspective view of the assembly of FIG. 2, in the partially assembled state;

FIG. 4 is a perspective view of the assembly of FIG. 2, in the assembled state;

FIG. 5 is an exploded view showing the individual components of an optoelectronic transceiver according to the invention; and

FIG. 6 shows two graphs with measured value curves, which illustrate the electromagnetic interference radiation from an optoelectronic transceiver according to the invention, compared to the electromagnetic interference radiation from a prior art transceiver.

### DESCRIPTION OF THE PREFERRED EMBODIMENTS:

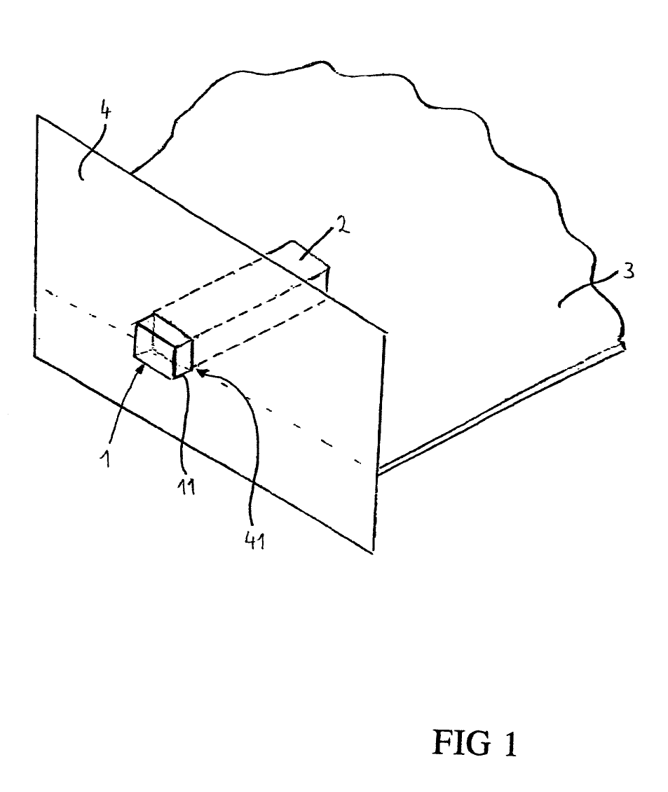

FIG. 1 shows, schematically, an assembly according to the invention having an optoelectronic transceiver 1, which is inserted into a shielding housing 2. The shielding housing 2 is mounted on a printed circuit board 3 which, for example, represents the main board of a computer.

The shielding housing 2 and the printed circuit board 3 are arranged in a metallic structure 4 which is, in particular, the rear wall (backplane) of a metallic housing, for example of a computer housing. An opening 41 is provided in the metallic structure 4, through which the optoelectronic transceiver 1 can be inserted into the shielding housing 2. The plug-in configuration of the optoelectronic transceiver 1 means that it can be connected in a simple manner to the printed circuit board 3 of an appliance, namely by plugging it into the shielding housing 2.

The optoelectronic transceiver 1 has a coupling region, which is illustrated only schematically in FIG. 1, and a plug holder 11, which represents an optical port for connecting an optical plug connector to the transceiver. The coupling region is arranged outside the metallic structure 4, and projects out of the opening 41 in the metallic structure, so that a coupling partner can be connected without any problems.

According to the invention, the coupling region 11 is composed of a plastic, in particular of an electromagnetically absorbent plastic. This prevents the coupling region 11, which projects out of the rear wall 3 of the transceiver 1, from acting as an antenna, and emitting electromagnetic interference radiation in an amplified manner. In fact, the use of plastic for the coupling region 11 reduces the emission of the electromagnetic waves. This is desirable in order to satisfy the requirements for low radiated electromagnetic emissions from the transceiver (electromagnetic compatibility).

Alternatively, the transceiver can also be permanently connected to the shielding housing, with the transceiver and the shielding housing both being mounted on the printed circuit board 3. In this case as well, the coupling region for holding a plug connector projects out of the metallic rear wall.

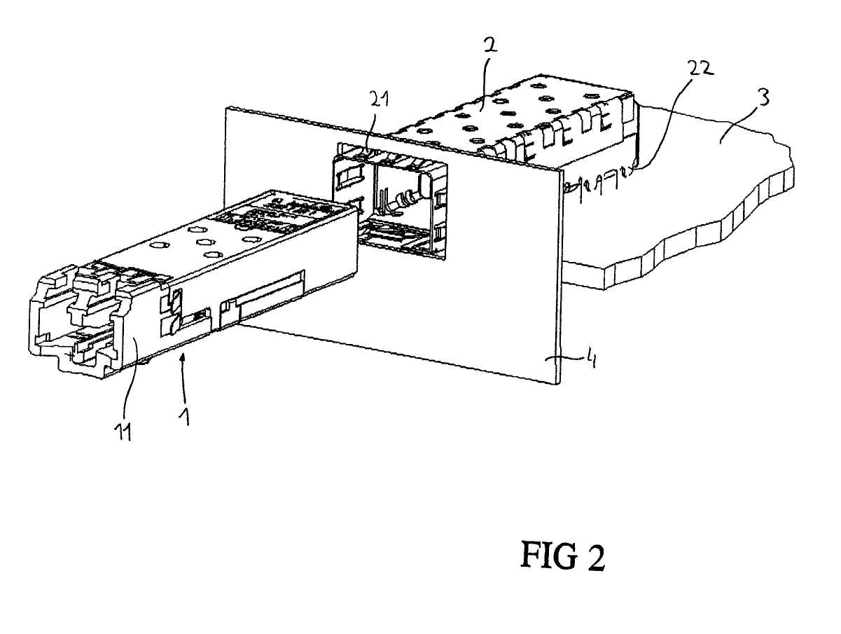

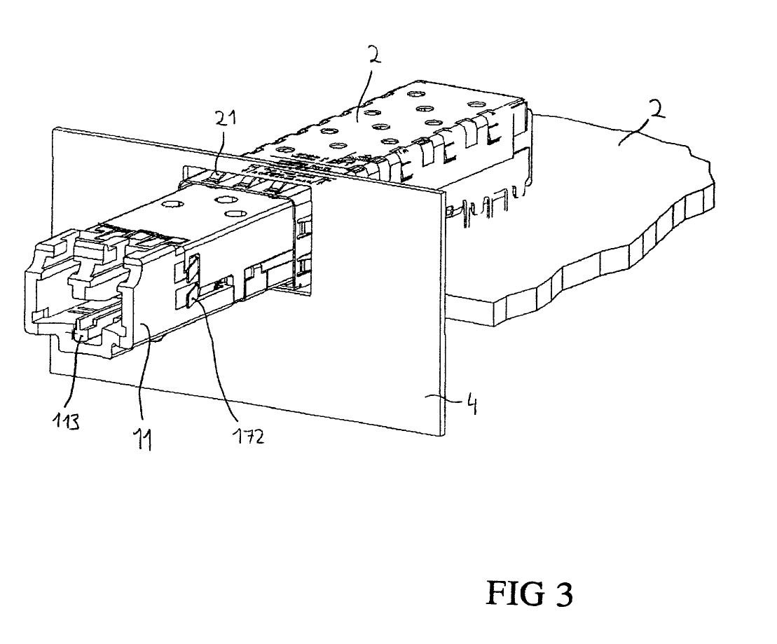

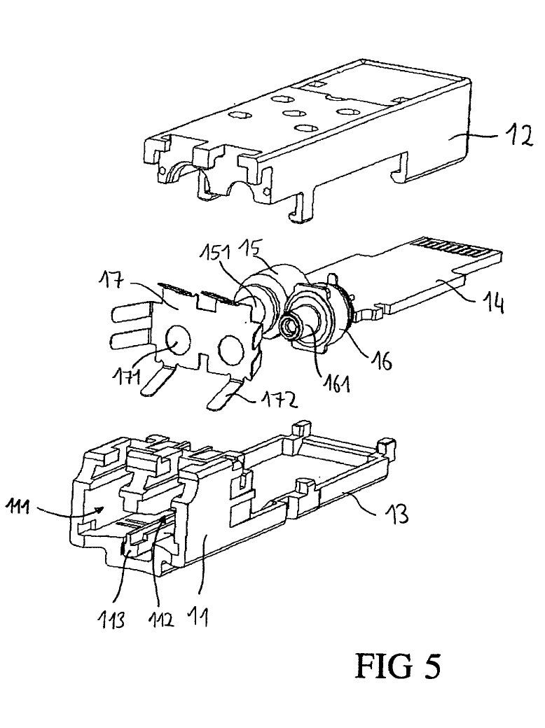

FIGS. 2 to 5 show one specific exemplary embodiment of the invention. According to FIG. 5, the optoelectronic transceiver according to the invention has a coupling region 11 (corresponding to the coupling region 11 in FIG. 1), an upper housing shell 12, a lower housing shell 13 which can be connected to the upper housing shell 12 by latching them together, a printed circuit board 14 located in between, an optoelectronic receiving component 16, an optoelectronic transmitting component 15, and an inner shielding plate 17. The latter will be referred to in the following text as shielding goggles.

The coupling region 11 is formed with two retaining apertures 111, 112 each of which is intended to hold an optical plug connector. An unlocking element 113 is used for easily accessible unlocking of plug connectors (not illustrated) which are inserted into the retaining apertures 111, 112.

Optical plug connectors which are inserted into the insertion apertures 111, 112 are coupled to the receiving component 16 and to the transmitting component 15, respectively, which each have an optoelectronic transducer and convert incoming light signals to electrical signals and, respectively, electrical signals to outgoing light signals. The receiving component 16 and the transmitting component 15 are connected to the printed circuit board 14, and the components 15, 16 are driven by electrical drive units, which are disposed on the printed circuit board 14.

The shielding goggles 17 are arranged behind the coupling region 11, at right angles to the insertion direction and parallel to a metallic rear wall (cf. the rear wall 4 in FIG. 1), as a single metallic part of the transceiver 1 and shields the RF-contaminated signal ground, which results in the region of the components 15, 16 and of the printed circuit board 14, from the coupling region 11. The shielding goggles 17 in this case have two openings 171 for holding flanges 151, 161 of the components 15, 16. The flanges have ferrules, each of which are coupled to optical wave guides in a coupling partner.

Furthermore, the shielding goggles 17 have contact lugs 172 for making contact with a metallic shielding housing corresponding to the shielding housing 2 in FIG. 1, by means of which electromagnetic interference potentials are dissipated to the shielding housing.

The coupling region 11, the upper housing shell 12, and the lower housing shell 13 are composed completely of plastic, so that they cannot receive or radiate interference potentials. However, it is also possible in alternative exemplary embodiments for the housing shells 12, 13 to be composed of metal, or at least to be metallized, as well. The coupling region 11 which projects out of the rear wall, however, is always formed from plastic.

The shielding goggles 17 together with their contact springs remain behind the plastic part 11, which projects out of the metallic structure. The shielding goggles 17 therefore do not represent a further discontinuity for producing radiated emissions.

FIGS. 2 to 4 show the transceiver 1 according to the invention with the coupling region 11, which is composed of plastic, during the various phases of insertion of the transceiver into a shielding housing 2, which is mounted on a printed circuit board 3 by means of pins 22. The shielding housing 2 in the illustrated exemplary embodiment comprises a metallic shielding plate and, in its front region, has curved contact springs 21, which are used to make contact between the metallic shielding plate 2 and a metallic rear wall 4. The metallic rear wall in this case provides a reference ground potential for the shielding housing. Shielding plates such as these are known per se.

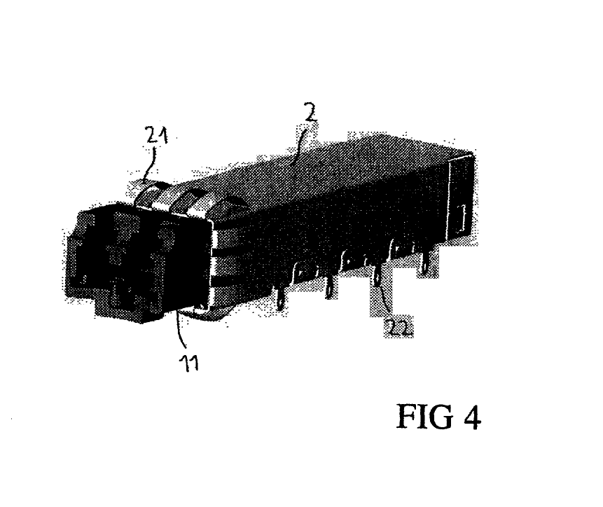

In the completely inserted state shown in FIG. 4, only the coupling region 11 now still projects out of the shielding housing 2. This coupling region 11 is located in front of an opening in the metallic rear wall, through which the transceiver 1 was inserted into the shielding housing 2, and which makes electrical contact with the shielding housing 2 by means of the contact springs 21.

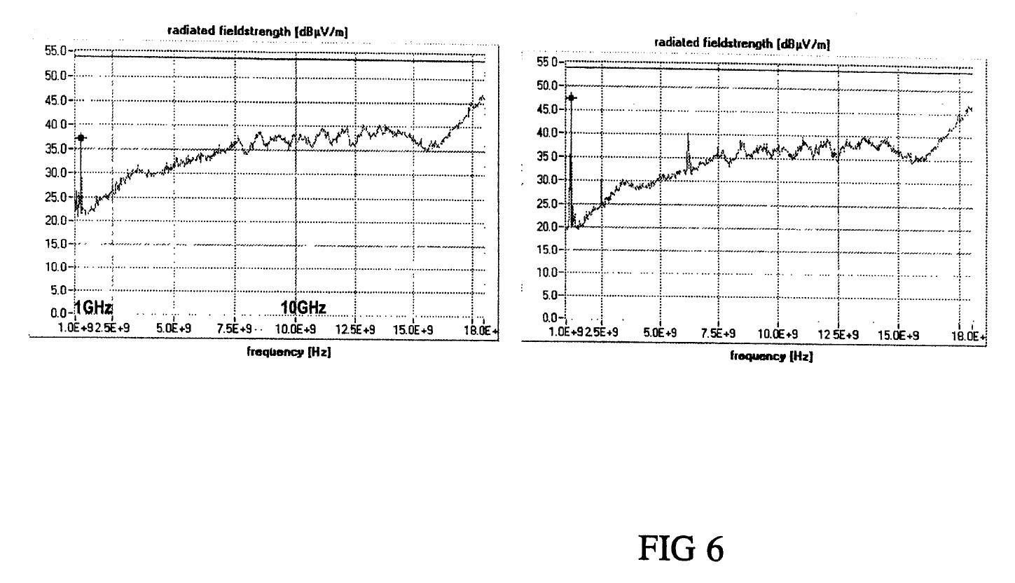

Since the coupling region 11 is formed from plastic, this reduces the emission of electromagnetic waves in the area of the coupling region 11. This has been verified experimentally, and is illustrated in the measurement curves in FIG. 6. In this case, the left-hand measurement curve shows the field strength of the emitted electromagnetic field as a function of the frequency for a transceiver according to the invention, and the right-hand measurement curve shows the field strength as a function of the frequency for a transceiver which is known from the prior art and has a metallic coupling region. It can be seen from the measurement curves that, particularly at a frequency of around 1.25 GHz, the radiated emissions from the transceiver according to the invention are reduced considerably (a field strength of 37 dBμV/m in comparison to a field strength of 47 dBμV/m). In addition, the transceiver according to the invention has no radiated emission peak, such as that which occurs at a frequency of about 6.25 GHz with the transceiver according to the prior art.

It will be understood that the embodiment of the invention is not restricted to the exemplary embodiments described above. The sole primary feature of the invention is that a coupling region of an electronic module—the coupling region projects out of a metallic structure when the module is mounted in a shielding housing—is formed from plastic.

We claim:

1. An electrical module, comprising:
a module body formed with a coupling region;
said module body being configured for insertion into a metallic structure-encased shielding housing on a printed circuit board;
said coupling region projecting out of the metallic structure encasing the shielding housing when the module is disposed in the shielding housing and said coupling region being composed of plastic.

2. The electrical module according to claim 1, wherein said module body is formed of a housing surrounding electrical components of the module, and said housing is composed of plastic.

3. The electrical module according to claim 2 configured as an optoelectronic transceiver, wherein said housing has two housing shells formed from plastic and enclosing a printed circuit board with electrical and optoelectronic components of the module.

4. The electrical module according to claim 1, wherein the module is formed with only a single metallic part, said single metallic part is an inner shielding plate formed, in an edge region thereof, with contacts for making contact with the shielding housing when the module is arranged in the shielding housing.

5. The electrical module according to claim 1, wherein the plastic is an electromagnetically absorbent plastic.

6. The electrical module according to claim 5, wherein the plastic has fillers for attenuating any electromagnetic field passing through the plastic.

7. An assembly, comprising:
a shielding housing disposed on a printed circuit board in a metallic structure, said metallic structure having a cutout formed therein;
an electrical module disposed in said shielding housing and having a coupling region for connection of a plug connector projecting out of said cut-out in said metallic structure, said electrical module being composed of plastic material.

8. An optoelectronic transceiver, comprising:
a coupling region for connection of a plug connector;
said coupling region, when the optoelectronic transceiver is inserted in a shielding housing on a printed circuit board, projecting out of a metallic structure encasing the shielding housing, said coupling region being composed of plastic.

9. The transceiver according to claim 8, which comprises a housing surrounding electrical components of the transceiver, and said housing is composed of plastic.

10. The transceiver according to claim 9, wherein said housing has two housing shells formed from plastic and enclosing a printed circuit board with electrical and optoelectronic components of the transceiver.

11. The transceiver according to claim 8, wherein the transceiver is formed with only a single metallic part, said single metallic part is an inner shielding plate formed, in an edge region thereof, with contacts for making contact with the shielding housing when the transceiver is arranged in the shielding housing.

12. The transceiver according to claim 8, wherein the plastic is an electromagnetically absorbent plastic.

13. The transceiver according to claim 12, wherein the plastic has fillers for attenuating any electromagnetic field passing through the plastic.
